(19) United States
(12) Patent Application Publication
(10) Pub. No.: US 2009/0243242 A1
(43) Pub. Date: Oct. 1, 2009

(54) Wheelbarrow Propulsion Device and Methods of Use

(76) Inventors: Bruce Houston, Erie, CO (US); Joe Moore, Broomfield, CO (US)

Correspondence Address: Leyendecker & Lemire, LLC, C/O PORTFOLIO IP, P.O. BOX 52050, MINNEAPOLIS, MN, 55402, US

(21) Appl. No.: 12/410,684

(22) Filed: Mar. 25, 2009

Related U.S. Application Data
(60) Provisional application No. 61/039,485, filed on Mar. 26, 2008.

(51) Int. Cl. B62B 1/00

(52) U.S. Cl. 280/47.31

(57) ABSTRACT

A wheelbarrow propulsion device and methods of its use are described. Embodiments of the wheelbarrow propulsion device enable a user to push against the device with the user's abdomen, in order to help propel a wheelbarrow. Some embodiments are adapted to fold out of the way when not needed, and some are adapted to yield if a user falls onto the device, thereby reducing likelihood or severity of injury to the user.

This application claims priority to, and incorporates by reference, U.S. provisional patent application 61/039,485, filed 26 Mar., 2008, having the same inventors as the present application. Provisional patent application 61/039,485 has the title Accessory Push Bar bolted to a Wheelbarrow.

### FIELD OF THE INVENTION

The present invention relates generally to accessories for assisting wheelbarrow propulsion, and methods of using such accessories.

### BACKGROUND

Pushing a loaded wheelbarrow typically presents challenges related to force and leverage. Force generated by a user to propel a wheelbarrow is typically transmitted from a user's shoulders, down through the user's arms and hands, to wheelbarrow handles. The user's arms therefore act as levers to amplify force required to propel the wheelbarrow, the amplified force being transmitted to the user's shoulders. Similarly, the user's lower arms can act as levers to amplify force on the user's upper arms. As a result, the user's arms, shoulders, and upper torso experience loads and concomitant stresses that are considerably greater than forces applied at the wheelbarrow handles.

A means for directing force from a user's legs and hips to a wheelbarrow, without suffering a mechanical disadvantage created by lever action of the user's arms, would improve wheelbarrow function. Some prior art devices address this problem but with substantial drawbacks. U.S. Pat. No. 7,195,248 (the '248 patent) discloses a wheelbarrow attachment device that facilitates pushing a wheelbarrow with a user's chest. U.S. Pat. No. 2,080,332 ('332) also discloses a wheelbarrow pushing device specifically adapted to a user pushing the wheelbarrow with his or her chest. The substantial drawbacks include leverage that directs a substantial portion of force exerted by a user's chest counterproductively, acting to rotate the wheelbarrow upwardly around an axis of a wheelbarrow wheel, rather than propelling the wheelbarrow forwardly. Moreover, each device presents a similar hazard to the user where the user lurches or falls, in which case a user's head, neck, or upper torso could strike the prior art device as the user falls or lurches downwardly. Neither prior art device is adapted to mitigate such a strike, and opportunity for substantial injury is therefore exacerbated by use of either device.

### BRIEF DESCRIPTION OF THE DRAWINGS

FIG. 1 is a side, perspective view of a prior art wheelbarrow.

FIG. 2 is a side, perspective view of a wheelbarrow propulsion device, according to one embodiment of the present invention.

FIG. 3 is side view of a wheelbarrow propulsion device, according to one embodiment of the present invention.

FIG. 4 is a rear, perspective view of a wheelbarrow propulsion device, according to one embodiment of the present invention.

### DETAILED DESCRIPTION

Embodiments of the present invention comprise a wheelbarrow propulsion device adapted to apply force to propel a wheelbarrow, the force being transmitted to the wheelbarrow from a user's abdomen without being transmitted through the user's arms. Some embodiments of wheelbarrow propulsion devices comprise a thrust pad against which a user pushes his or her abdomen in order to transmit propelling force to the wheelbarrow. The thrust pad is coupled to the wheelbarrow and facilitates transmission of propelling force from the user to the wheelbarrow. The thrust pad is typically, although not necessarily, coupled to a pan or handle of the wheelbarrow.

Embodiments of the wheelbarrow propulsion device are adapted to fold, pivot, or otherwise change configuration to be out of a user's way when not in use, so as not to impede or obstruct wheelbarrow use when use of the push device is unwanted or unneeded. In some embodiments, the wheelbarrow propulsion device is adapted to fold, collapse, or otherwise yield in response to a blow or force from above, such that if a user lurches or falls into or onto the device, the device yields, and a user's injury potential is thus reduced.

### Terminology

The terms and phrases as indicated in quotation marks ( “”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct connection between the identified elements, components, or objects. Often the manner of the coupling will be related specifically to the manner in which the two coupled elements interact.

The term “approximately,” as used in this specification and appended claims, refers to plus or minus 5% of the value given.

The term “wheelbarrow,” as used in this specification and appended claims, includes a cart having one or two wheels disposed at or proximate a front end, and two handles disposed at a rear end. A pan adapted to carry cargo is typically disposed mostly above and behind the one or two wheels, and in front of the two handles. A user typically propels the wheelbarrow forward by grasping and pushing forward on the handles, usually while lifting the handles in order to lift the wheelbarrow off of resting struts. The pan is typically, but not necessarily, an open top tub or bucket with a capacity of approximately 4 cubic feet to 10 cubic feet, although some wheelbarrows have pans that are larger or smaller than approximately 4 to 10 cubic feet. Some embodiments of pans are flat or very shallow and are better described as platforms than tubs.

The term “abdomen,” as used in this specification and appended claims, refers to a section of a human torso extending from sternum to groin, and limited to a front or ventral side of that section of the human torso. Where a person is standing relatively upright, the abdomen is thus disposed generally below the person's sternum and chest, and above the person's legs.

The term “prominent position,” as used in this specification and appended claims, refers to disposition of a thrust pad or similar wheelbarrow propulsion device component in a position where the thrust pad or similar component is readily pressed or pushed against by a user's abdomen, to propel or help propel a wheelbarrow forward while the user grasps the wheelbarrow by its handles. A prominent position is typically proximate the handles and in a range of 0 inch to 15 inches higher than the handles when the wheelbarrow is resting in an upright position. A typical user is a human adult between 4′ 10″ and 7′ tall.

The term “unobtrusive position,” as used in this specification and appended claims, refers to disposition of a thrust pad or similar wheelbarrow propulsion device component where the thrust pad or similar component is out of the way of a user as the user grasps the wheelbarrow by its handles and pushes or propels the wheelbarrow in the normal manner. A thrust pad typically remains coupled to the wheelbarrow when in an unobtrusive position.

The term “yield,” or “yields,” as used in this specification and appended claims, refers to action of a wheelbarrow propulsion device, or a portion thereof, in which the wheelbarrow propulsion device or portion thereof substantially deflects, moves, or gives way in response to a substantially downward force of 2 pounds or more, without sustaining structural damage or permanently deforming As used herein, yield is a verb that denotes movement relative to a wheelbarrow to which the wheelbarrow propulsion device is coupled. In order to yield, the wheelbarrow propulsion device or a portion thereof moves or deflects at least 2 inches relative to the wheelbarrow to which the wheelbarrow propulsion device is coupled.

### Prior Art Wheelbarrow

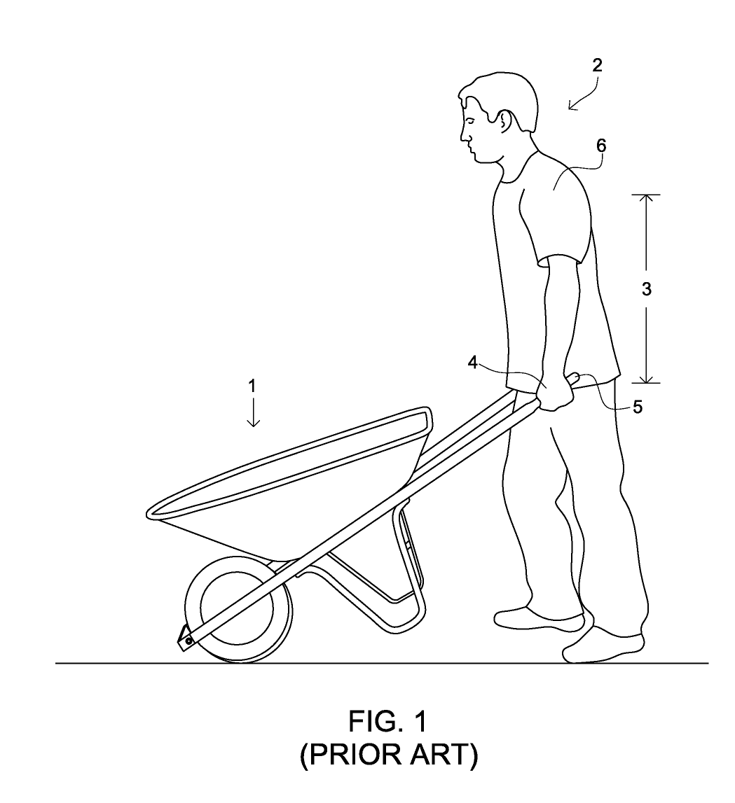

A prior art wheelbarrow 1 is shown being pushed by a user 2 in FIG. 1. The user is pushing against the wheelbarrow handles with a total propulsion force of 50 pounds, split approximately evenly between each hand 4 of the user. An arm length 3 of the user is approximately 20 inches, and each hand of the user is pushing against a wheelbarrow handle 5 with a propulsion force of 25 lbs. Each shoulder 6 of the user therefore experiences approximately 41.7 foot pounds of torque because a propulsion force of 25 lbs is levered by the 20 inches of arm length. Accordingly, in order to exert a total pushing force of 50 pounds, the shoulders of the user together incur a shoulder propulsion load of approximately 83.3 foot pounds of torque.

### A First Embodiment Wheelbarrow Propulsion Device

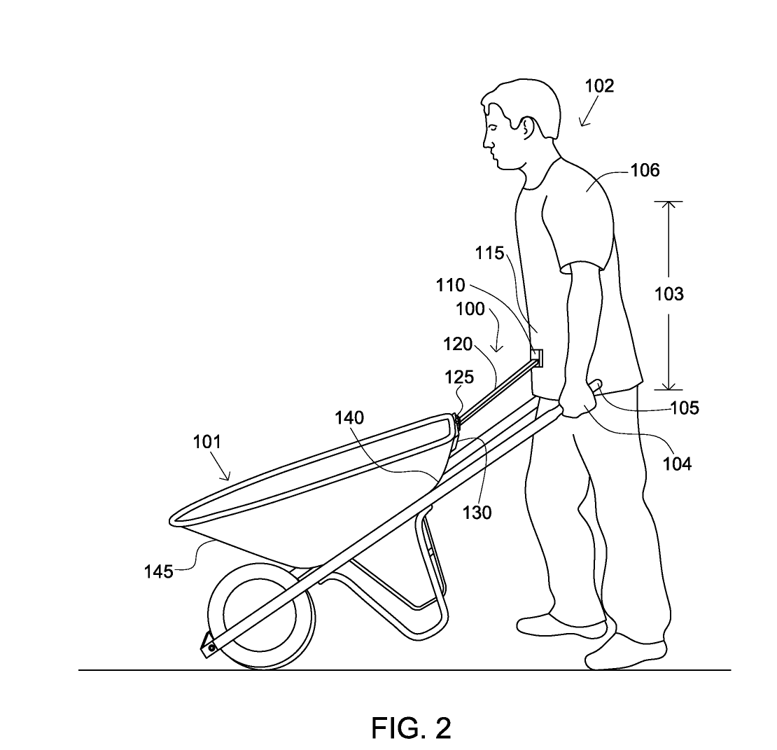

A first embodiment wheelbarrow propulsion device 100 is illustrated in FIGS. 2-4. The wheelbarrow propulsion device is being pushed by a user 102 in FIG. 2, in order to propel a wheelbarrow 101. The first embodiment wheelbarrow propulsion device comprises a thrust pad 110, a connecting member 120, a hinge 125, a coupling adapter 130, and a position limiter 135. The position limiter is not identified in FIG. 2 because it is difficult to see in that figure. The coupling adapter is bolted to a rear portion 140 of a wheelbarrow pan 145. A thickness 131 of the coupling adapter is preferably between 1 inch and 4 inches, more preferably between 1.5 and 3 inches, and most preferably approximately 2 inches. Among other things, the coupling adapter serves to offset the connecting member away from the wheelbarrow rear portion, which facilitates revolution of the connecting member about the rotational axis of the hinge 125. The thickness of the coupling adapter in the first embodiment determines an amount of offset.

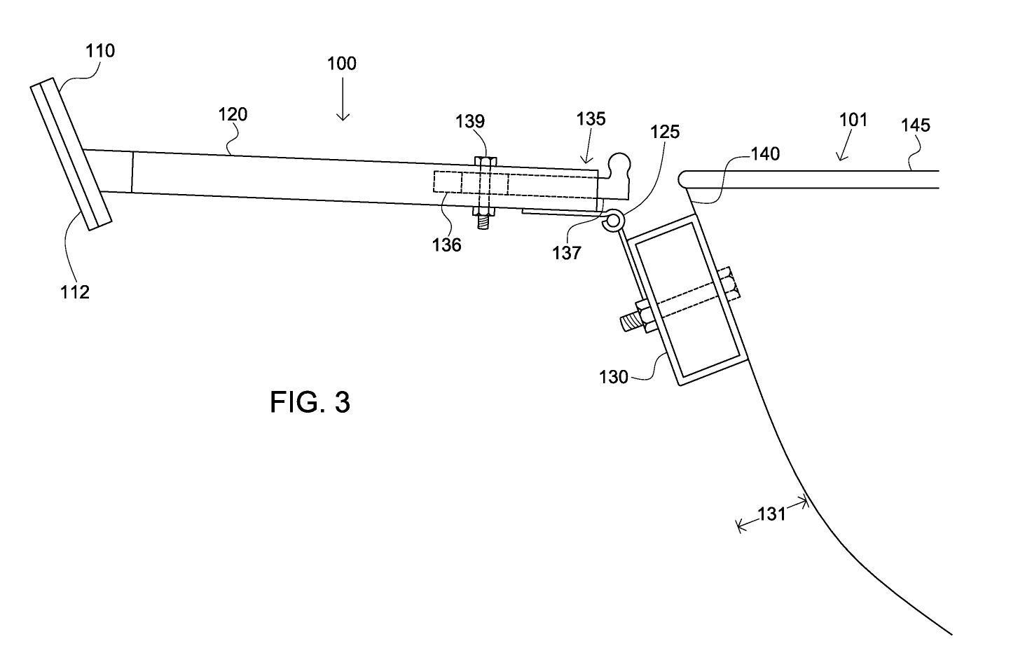

The thrust pad 110 is adapted to comfortably press against an abdomen 115 of the user 102 with considerable force. As best illustrated in FIG. 3, the thrust pad comprises ½ inch neoprene padding to provide a cushioned surface 112 against which the user pushes. The connecting member 120 of the wheelbarrow propulsion device 100 comprises a substantially rigid metal bar approximately 13 inches long, which is attached directly to the hinge 125.

The hinge 125 is a configuration adjustment device, which in the first embodiment enables the connecting member 120 to pivot about a rotational axis of the hinge such that the thrust pad 110 describes an arc as the thrust pad partially circumvolves the hinge. Embodiments of configuration adjustment devices enable wheelbarrow propulsion devices of the present invention to adjust between a first configuration, in which the thrust pad is disposed in a prominent position and the wheelbarrow propulsion device is therefore adapted to aid propulsion of the wheelbarrow 101 by a user, and a second configuration, in which the thrust pad is disposed in an unobtrusive position and therefore the wheelbarrow propulsion device is configured to be out of the way of a user. Where the wheelbarrow propulsion device is in the second configuration, the wheelbarrow propulsion device does not impede or obstruct normal use of the wheelbarrow, and is not in a position to readily assist wheelbarrow propulsion.

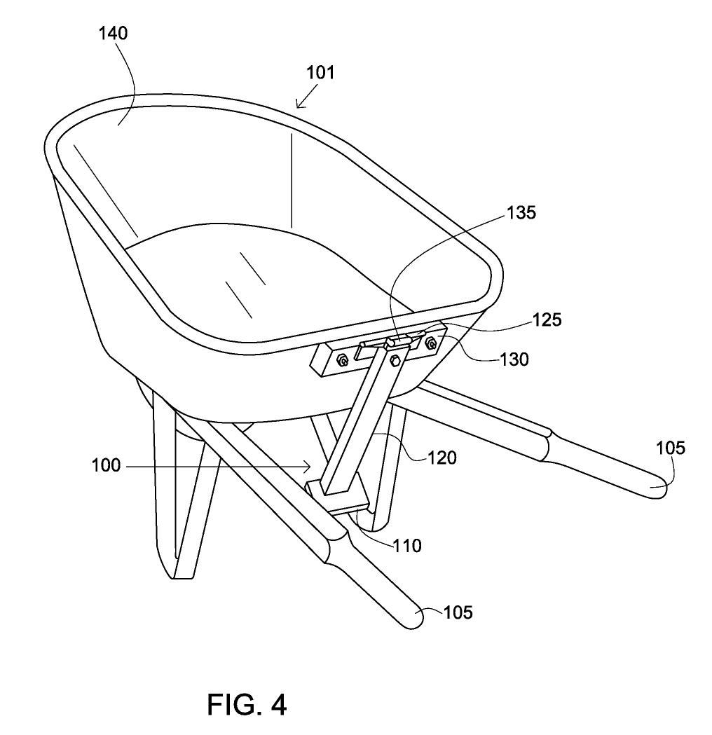

The first embodiment wheelbarrow propulsion device 100 is illustrated in a first configuration in FIGS. 2-3, and in a second configuration in FIG. 4. As shown in FIG. 2, the first configuration comprises the thrust pad 110 being disposed in a prominent position proximate the handles 105 of the wheelbarrow 101. So disposed, approximately between and slightly above the handles, the thrust pad of the first embodiment is in contact with the abdomen 115 of the user 102, where the user is in a normal position for using the wheelbarrow. The thrust pad and connecting member are prevented from swinging down out of the first configuration, under the weight of the thrust pad and connecting member, due to friction provided by the hinge 125. That friction is readily overcome by a downward force of preferably between 2 pounds and 30 pounds, more preferably between 8 pounds and 20 pounds, and most preferably approximately 10 pounds. Embodiments of the present invention hold the thrust pad in a first configuration by a variety of means, including, but not limited to, set screws, tightly fitting hinge pins or axles, or threaded hinge pins or axles that are fitted with threaded fasteners such as nuts or bolts that are tightened to achieve appropriate friction in the hinge.

The user 102 in FIG. 2 is pushing against the thrust pad 110 to assist propelling the wheelbarrow 101 forward. As can be seen in FIG. 2, the wheelbarrow propulsion device 100 in the first configuration would obstruct or impede the user if the user was to try to use the wheelbarrow normally, without pushing on the thrust pad. The connecting member 120 is preferably between 5 inches and 25 inches long, more preferably between 9 and 19 inches long, and most preferably approximately 13 inches long.

As illustrated in FIG. 4, the first embodiment wheelbarrow propulsion device 100 is in the second configuration with the thrust pad 110 being disposed in an unobtrusive position, the thrust pad and connecting member 120 having rotated downwardly about the rotational axis of the hinge 125, such that the thrust pad is tucked out of the way. Where a user grasps the wheelbarrow 101 by the handles 105 and seeks to propel the wheelbarrow in a normal fashion, the wheelbarrow propulsion device is tucked out of the way and does not, nor is it adapted to, aid in propulsion of the wheelbarrow so long as it remains in the second configuration. Similarly, the wheelbarrow propulsion device in the second configuration, as illustrated in FIG. 4, does not impede or obstruct a user.

Some embodiments of wheelbarrow propulsion devices are adapted to assume first and second configurations by use of configuration adjusting devices other than, or in addition to, hinges. For example, for embodiments of a wheelbarrow propulsion device having a connecting member endowed with telescopic capability, the telescopic connecting member is a configuration adjusting device as follows. The telescopic connecting member elongates to a achieve a first configuration wherein a thrust pad is disposed relatively away from a wheelbarrow pan and is proximate wheelbarrow handles, where a user may readily push against the thrust pad with his or her abdomen to help propel the wheelbarrow, while the user also grasps the wheelbarrow handles and pushes or stabilizes the wheelbarrow using the handles. Alternatively, the telescopic connecting member shortens to achieve a second configuration wherein the thrust pad is disposed relatively closer to the wheelbarrow pan and further from the wheelbarrow handles, such that it is awkward or difficult for the user to press against the thrust pad while also grasping the wheelbarrow handles and pushing or stabilizing the wheelbarrow using the handles.

As illustrated in FIG. 2, the user 102 is exerting with his abdomen 115 against the thrust pad 110, a propulsion force of approximately 30 pounds. The user in FIG. 2 is also exerting a propulsion force of approximately 10 pounds with each hand 104. As in FIG. 1, the user in FIG. 2 has an arm length 103 of 20 inches. Therefore, as in FIG. 1, the total propulsion force is 50 pounds. However, each shoulder 106 of the user in FIG. 2 experiences only approximately 16.7 foot pounds of torque, and the shoulders collectively experience a shoulder propulsion load of approximately 33.3 foot pounds of torque, a reduction of approximately 50 foot pounds of torque compared to circumstances depicted in FIG. 1. The first embodiment wheelbarrow propulsion device thus dramatically reduces load on a user's shoulders by shifting load to a user's abdomen; use of the wheelbarrow propulsion device has resulted in reducing shoulder propulsion load by approximately 50 foot pounds while shifting only 30 pounds of propulsion force to the abdomen 115 of the user.

As is apparent to a person of ordinary skill in the art, the first embodiment wheelbarrow propulsion device 100 is adapted to yield if a user falls onto or into the wheelbarrow propulsion device. As can be seen by examining FIGS. 2 and 3, were a an object to strike or press downwardly against the thrust pad 110 or the connecting member 120 with substantial force, the hinge 125 would allow the thrust pad and connecting member to move or swing downwardly. Accordingly, if the object is a user's head, chest, or other body part, that strikes or lands on the thrust pad or connecting member because the user stumbles, falls, lurches, or otherwise unintentionally strikes or lands on the thrust pad or connecting member, injury to the user would likely be mitigated because the thrust pad and connecting member yield, moving or swinging downwardly under the downward force exerted by the falling user on the thrust pad or connecting member.

As best illustrated in FIG. 2, the connecting member 120 is projecting from the rear portion 140 of the wheelbarrow pan 145 at a slightly upward angle. Accordingly, a propulsion force exerted by the abdomen 115 of the user may tend to force the thrust pad 110 and connecting member to move or revolve upwardly about the rotational axis of the hinge 125. The position limiter 135 is used to adjust a degree to which the connecting member rotates upwardly about the rotational axis of the hinge, i.e. to adjust an upper limit to a range of motion of the connecting member, as explained below. Where the thrust pad 110 has reached an upper limit of its range of motion as it revolves around the rotational axis, the thrust pad is in its uppermost position. The thrust pad is typically at its uppermost position when the wheelbarrow propulsion device is in the first configuration.

As best illustrated in FIG. 3, the upper limit to the range of motion of the connecting member 120 as it pivots about the rotational axis of the hinge 125 is adjustable by use of the position limiter 135. The position limiter comprises an overlapping portion 136 that overlaps the connecting member and resides inside the connecting member. The position limiter further comprises an extending portion 137 that extends beyond an end of the connecting member. The position limiter is adjustable so that a length of the extending portion is adapted to be changed. In some embodiments, the overlapping portion overlaps the connecting member externally, rather than or in addition to internally.

As is apparent to a person of ordinary skill in the art, the position limiter 135 is adapted to limit the range of motion of the connecting member 120 by impinging on the coupling adapter 130 or the rear portion 140 of the wheelbarrow pan 145. Where the position limiter slides farther out of the connecting member, such that the length of the extending portion 137 becomes greater, the position limiter places greater limitation on the range of motion of the connecting member by impinging on the coupling adapter or rear portion of the wheelbarrow pan lower (earlier) in the connecting member's upward arc of travel. Where the position limiter slides into the connecting member, and the length of the extending portion is therefore reduced, the position limiter places less limitation on the range of motion of the connecting member, by contacting the coupling adapter or rear portion of the wheelbarrow pan higher (later) in the connecting member's upward arc of travel. The position limiter is reversibly secured in place using the anchor bolt 139. The anchor bolt is loosened to adjust the length of the extending portion and tightened to secure the position limiter in position.

In typical use, a user adjusts a wheelbarrow propulsion device to a second configuration with a thrust pad disposed in an unobtrusive position, and propels an empty wheelbarrow to a location immediately proximate a load to be moved. The user then loads the wheelbarrow, and subsequently adjusts the wheelbarrow propulsion device to a first configuration with a thrust pad at its uppermost position, the uppermost position being a prominent postion. If the user is dissatisfied with the uppermost position of the thrust pad, the user may adjust the position limiter to achieve a new uppermost position. With the thrust pad properly positioned, the user typically grasps and lifts the wheelbarrow handles, such that wheelbarrow resting struts raise off the ground. The user then presses his or her abdomen against the thrust pad, and propels the wheelbarrow forward by pushing forwardly with the user's abdomen, simultaneously pushing or stabilizing the wheelbarrow with the handles. Upon emptying the wheelbarrow, the user may adjust the wheelbarrow propulsion device to the second configuration, and propel the empty wheelbarrow to a location proximate a load to be moved.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A wheelbarrow combination comprising:
a wheelbarrow, the wheelbarrow comprising:
a pan;
two or more handles;
a wheel;
a wheelbarrow propulsion device, the wheelbarrow propulsion device comprising:
a thrust pad coupled to the wheelbarrow;
a first configuration in which the thrust pad is disposed in a prominent position; and
a second configuration in which the thrust pad is disposed in an unobtrusive position.

2. The wheelbarrow combination of claim 1, wherein the wheelbarrow propulsion device further comprises a configuration adjustment device, the configuration adjustment device being coupled to the thrust pad.

3. The wheelbarrow combination of claim 2, wherein the configuration adjustment device is a hinge, the hinge comprising a rotational axis.

4. The wheelbarrow combination of claim 3, wherein the thrust pad is coupled to the hinge, and the thrust pad is adapted to adjust from the first configuration to the second configuration by partially revolving around the hinge rotational axis.

5. The wheelbarrow combination of claim 1, wherein the thrust pad is disposed in the first configuration and is adapted to yield in response to a downward force, the downward force being between 2 pounds and 30 pounds.

6. The wheelbarrow combination of claim 2, wherein the thrust pad is disposed in the first configuration and is adapted to yield in response to a downward force, the downward force being between 2 pounds and 30 pounds.

7. The wheelbarrow combination of claim 3, wherein the wheelbarrow propulsion device is disposed in the first configuration and the thrust pad is adapted to yield in response to a downward force, the downward force being between 2 pounds and 30 pounds.

8. The wheelbarrow combination of claim 4, further comprising a position limiter, the position limiter adjustably limiting a range that the thrust pad can revolve around the hinge.

9. The wheelbarrow combination of claim 8, wherein:
the wheelbarrow is upright;
the rotational axis is substantially horizontal;
the wheelbarrow propulsion device is in the first configuration;
the thrust pad is disposed at an uppermost position; and
the uppermost position is limited by the position limiter.

10. A method of using a wheelbarrow propulsion device comprising:
providing the wheelbarrow combination of claim 7; and
propelling the wheelbarrow while pushing against the thrust pad with an abdomen.

11. A method of using a wheelbarrow propulsion device comprising:
providing the wheelbarrow combination of claim 9; and
propelling the wheelbarrow while pushing against the thrust pad with an abdomen.

12. The method of using a wheelbarrow propulsion device of claim 11, further comprising changing the uppermost position by adjusting the position limiter.

13. A method of using a wheelbarrow propulsion device comprising:
providing a wheelbarrow;
providing a wheelbarrow propulsion device, the wheelbarrow propulsion device comprising a thrust pad coupled to the wheelbarrow;
placing the wheelbarrow propulsion device in a first configuration, in which the thrust pad is disposed in a prominent position; and
propelling the wheelbarrow while pushing against the thrust pad with an abdomen.

14. The method of using a wheelbarrow propulsion device of claim 13, further comprising placing the wheelbarrow propulsion device in a second configuration, in which the thrust pad is disposed in an unobtrusive position.

15. The method of using a wheelbarrow propulsion device of claim 10, further comprising propelling the wheelbarrow with the wheelbarrow propulsion device in the second configuration.

16. A wheelbarrow propulsion device comprising;
a thrust pad;
a connecting member, the connecting member being coupled to the thrust pad and comprising a rigid bar having a length between 5 inches and 25 inches;
a hinge, the hinge comprising a rotational axis.

17. The wheelbarrow propulsion device of claim 16, further comprising a position limiter, the position limiter comprising:
an overlapping portion, the overlapping portion overlapping the connecting member;
an extending portion, the extending portion extending beyond an end of the connecting member.

18. The wheelbarrow propulsion device of claim 17, wherein a length of the extending portion is adapted to be adjusted.

19. The wheelbarrow propulsion device of claim 16, further comprising a coupling adapter, the coupling adapter being directly coupled to the hinge and having a thickness of between 1 inch and 4 inches.

20. The wheelbarrow propulsion device of claim 19, wherein revolution of the connecting member about the rotational axis is limited by the position limiter impinging on the coupling adapter.
